(19) United States
(12) Patent Application Publication
(10) Pub. No.: US 2010/0325344 A1
(43) Pub. Date: Dec. 23, 2010

(54) DATA WRITING METHOD FOR FLASH MEMORY AND CONTROL CIRCUIT AND STORAGE SYSTEM USING THE SAME

(75) Inventor: Kheng-Chong Tan, Hsinchu County (TW)

Correspondence Address: J C PATENTS, 4 VENTURE, SUITE 250, IRVINE, CA, 92618, US

(73) Assignee: PHISON ELECTRONICS CORP., Miaoli (TW)

(21) Appl. No.: 12/542,158

(22) Filed: Aug. 17, 2009

(30) Foreign Application Priority Data
Jun. 23, 2009 (TW) 98121001

(51) Int. Cl. G06F 12/02

(52) U.S. Cl. 711/103; 711/E12.008

(57) ABSTRACT

A data writing method for writing data into a flash memory chip is provided, wherein the flash memory chip includes a plurality of physical units. The data writing method includes providing a flash memory control circuit and configuring a plurality of logical units, wherein each logical unit is mapped to at least one physical unit. The data writing method also includes configuring a plurality of logical addresses and mapping the logical addresses to the logical units, wherein at least one logical unit is mapped to at least two non-continuous logical addresses. The data writing method further includes writing the data from a host system into the corresponding physical units according to the logical units mapped to the logical addresses through the flash memory control circuit. Thereby, the data to be moved while writing data into the physical units is reduced, and accordingly the data writing speed is effectively increased.

### CROSS-REFERENCE TO RELATED APPLICATION

This application claims the priority benefit of Taiwan application serial no. 98121001, filed on Jun. 23, 2009. The entirety of the above-mentioned patent application is hereby incorporated by reference herein and made a part of specification.

### BACKGROUND

1. Technology Field

The present invention generally relates to a flash memory control circuit, and more particularly, to a flash memory control circuit which effectively improves data writing efficiency, a flash memory storage system, and a data writing method thereof.

2. Description of Related Art

Along with the widespread of digital cameras, cell phones, and MP3 in recently years, the consumers' demand to storage media has increased drastically. Flash memory is one of the most adaptable memories for such battery-powered portable products due to its characteristics such as data non-volatility, low power consumption, small volume, and non-mechanical structure. A solid state drive (SSD) is a storage device which uses a NAND flash memory as its storage medium.

Due to the physical characteristic of flash memories, each memory cell in a flash memory can only be program in a single direction (i.e., the bits in each memory cell can only be programmed from 1 to 0). Thus, while writing data into a memories cell of a flash memory, data previously stored in the memory cell has to be erased before the new data can be written into the memory cell. In order to write data efficiently into a flash memory storage device, the flash memory storage device is usually designed in such a way that the physical units in the flash memory storage device are alternatively used for storing data.

Generally speaking, regarding the design of a flash memory storage system, the flash memory physical blocks therein are grouped into a plurality of physical blocks, and these physical blocks are grouped into a plurality of physical units. And, in the operation of the flash memory storage system, the physical units are further grouped into a data area and a spare area. The physical units in the data area are used for storing valid data written by write commands, and the physical units in the spare area are used for substituting the physical units in the data area when the write commands are executed. To be specific, when a flash memory storage system receives a write command from a host and accordingly is about to update (or write data into) a physical unit in the data area, the flash memory storage system selects a physical unit from the spare area and writes the old valid data in the physical unit to be updated and the new data into the physical unit selected from the spare area. After that, the flash memory storage system links the physical unit containing the new data to the data area, then erases the physical unit to be updated in the data area and links it to the spare area. The flash memory storage system provides logical units to the host in order to allow the host to access the physical units which are alternatively used for storing data. Namely, the flash memory storage system records and updates the mapping relationship between the logical units and the physical units in the data area in a mapping table to reflect the alternation between the physical units. Thus, the host simply accesses the logical units while the flash memory storage system accesses the corresponding physical units according to the mapping table.

Generally speaking, when a flash memory storage device is manufactured, the manufacturer tests the access speed of the flash memory storage device by actually writing test data into the flash memory storage device. The test data is written into the flash memory storage device in test units (or storage units) which are larger than aforementioned logical units and physical units. Thus, when the flash memory storage device spends a lot of time on moving old valid data when it writes data alternatively into the physical units. Accordingly, the access speed of the flash memory storage device is not very satisfactory, and which will affect the market price of the flash memory storage device.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

Accordingly, the present invention is directed to a data writing method which can effectively increase the speed of writing data into a flash memory chip.

The present invention is directed to a flash memory control circuit which can execute foregoing data writing method so that the speed of writing data into a flash memory chip is effectively increased.

The present invention is directed to a flash memory storage system which can execute foregoing data writing method so that the speed of writing data into a flash memory chip is effectively increased.

According to an exemplary embodiment of the present invention, a data writing method for writing data into a flash memory chip is provided, wherein the flash memory chip includes a plurality of physical units. The data writing method includes providing a flash memory control circuit and configuring a plurality of logical units, wherein each of the logical units is mapped to at least one of the physical units. The data writing method also includes configuring a plurality of logical addresses to be accessed by a host system and mapping the logical addresses to the logical units, wherein at least one of the logical units is mapped to at least two of the logical addresses which are non-continuous. The data writing method further includes writing the data from the host system into the corresponding physical units according to the logical units mapped to the logical addresses by the flash memory control circuit, wherein data stored in the logical addresses mapped to the same logical units is simultaneously erased.

According to an exemplary embodiment of the present invention, a flash memory control circuit is provided, wherein the flash memory control circuit controls a flash memory chip to write data from a host system into a plurality of physical blocks of the flash memory chip. The flash memory control circuit includes a microprocessor unit, a flash memory interface unit, a host interface unit, and a memory management unit. The flash memory interface unit is coupled to the microprocessor unit and used to connect the flash memory chip. The host interface unit is coupled to the microprocessor unit and used to connect a host system. The memory management unit is coupled to the microprocessor unit and used to configure a plurality of logical units mapped to the physical units and a plurality of logical addresses to be accessed by the host system. Besides, the memory management unit maps the logical addresses to the logical units, wherein at least one of the logical units is mapped to at least two of the logical addresses which are non-continuous, and each of the logical units is mapped to at least one of the physical units. Moreover, the memory management unit writes the data from the host system into the corresponding physical units according to the logical units mapped to the logical addresses, wherein data stored in the logical addresses mapped to the same logical units is simultaneously erased.

According to an exemplary embodiment of the present invention, a flash memory storage system for storing data from a host system is provided. The flash memory storage system includes a connector, a flash memory chip, and a flash memory controller, wherein the connector is used to connect a host system, the flash memory chip has a plurality of physical blocks, and the flash memory controller is coupled to the connector and the flash memory chip. The flash memory controller configures a plurality of logical units mapped to the physical units and a plurality of logical addresses to be accessed by the host system, and the flash memory controller maps the logical addresses to the logical units, wherein at least one of the logical units is mapped to at least two of the logical addresses which are non-continuous, and each of the logical units is mapped to at least one of the physical units. When the host system stores the data at a logical address, the flash memory controller writes the data from the host system into the corresponding physical unit according to the logical unit mapped to the logical address, wherein data stored in the logical addresses mapped to the same logical units is simultaneously erased.

As described above, in the data writing method provided by the present invention, the logical addresses are mapped to the logical blocks in a non-continuous manner, so that data in the storage units that exceeds the capacity of one logical unit is collected in a specific logical unit. Thereby, the data to be moved while writing data into the physical units is reduced, and accordingly the data writing speed is effectively increased.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a flash memory storage device according to an exemplary embodiment of the present invention.

FIG. 2 is a schematic block diagram of a flash memory chip according to an exemplary embodiment of the present invention.

FIGS. 3A˜3D illustrate the operations of a flash memory chip according to an exemplary embodiment of the present invention.

FIG. 4 illustrates the mappings between logical addresses and logical blocks according to an exemplary embodiment of the present invention.

FIG. 5 illustrates the mappings between logical addresses and logical blocks according to another exemplary embodiment of the present invention.

FIG. 6 is a flowchart of a data writing method according to an exemplary embodiment of the present invention.

FIG. 7 is a detailed flowchart of step S505 in FIG. 6 according to an exemplary embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended equations that are both conjunctive and disjunctive in operation. For example, each of the equations “at least on of A,B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

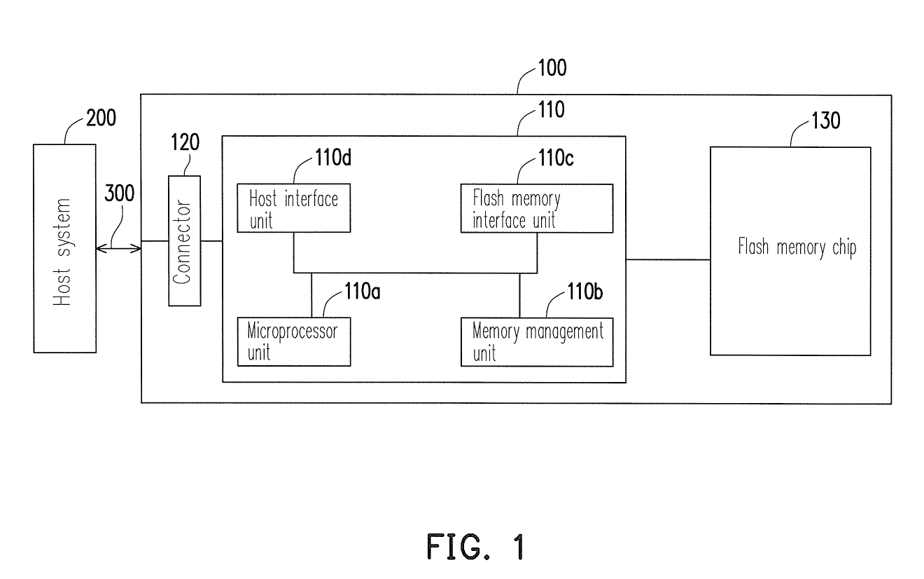

FIG. 1 is a schematic block diagram of a flash memory storage device according to an exemplary embodiment of the present invention.

Referring to FIG. 1, the flash memory storage device 100 usually works together with a host system 200 so that the host system 200 can write data into or read data from the flash memory storage device 100. In the present embodiment, the flash memory storage device 100 is a memory card. However, in another embodiment of the present invention, the flash memory storage device 100 may also be a solid state drive (SSD) or a flash drive.

The flash memory storage device 100 includes a flash memory controller (also referred to as a flash memory control circuit) 110, a connector 120, and a flash memory chip 130.

The flash memory controller 110 executes a plurality of logic gates or control instructions implemented in hardware or firmware form and performs data writing, reading, and erasing operations to the flash memory chip 130 according to instructions of the host system 200. The flash memory controller 110 includes a microprocessor unit 110a, a memory management unit 110b, a flash memory interface unit 110c, and a host interface unit 110d.

The microprocessor unit 110a cooperates with the memory management unit 110b, the flash memory interface unit 110c, and the host interface unit 110d to carry out various operations of the flash memory storage device 100.

The memory management unit 110b is coupled to the microprocessor unit 110a, and executes a block management mechanism and a data writing mechanism according to the present exemplary embodiment.

In the present embodiment, the memory management unit 110b is implemented in the flash memory controller 110 in a firmware form. For example, the memory management unit 110b including a plurality of program instructions is recorded in a program memory (for example, a read only memory (ROM)), and the program memory is embedded into the flash memory controller 110. When the flash memory storage device 100 is in operation, the program instructions of the memory management unit 110b are executed by the microprocessor unit 110a to accomplish the block management mechanism and the data writing mechanism according to the present embodiment.

In another embodiment of the present invention, the program instructions of the memory management unit 110b may also be stored in a specific area (for example, the system area of a flash memory for storing system data) of the flash memory chip 130 in a software form. Similarly, the program instructions of the memory management unit 110b are executed by the microprocessor unit 110a when the flash memory storage device 100 is in operation. In yet another embodiment of the present invention, the memory management unit 110b may also be implemented in the flash memory controller 110 in a hardware form.

The flash memory interface unit 110c is coupled to the microprocessor unit 110a and used to access the flash memory chip 130. Namely, data to be written into the flash memory chip 130 is converted by the flash memory interface unit 110c into a format acceptable to the flash memory chip 130.

The host interface unit 110d is coupled to the microprocessor unit 110a and used to receive and identify instructions from the host system 200. Namely, the instructions and data received from the host system 200 are transmitted to the microprocessor unit 110a through the host interface unit 110d. In the present exemplary embodiment, the host interface unit 110d is a secure digital (SD) interface. However, the present invention is not limited thereto, and the host interface unit 110d may also be a serial advanced technology attachment (SATA) interface, a universal serial bus (USB) interface, an Institute of Electrical and Electronic Engineers (IEEE) 1394 interface, a peripheral component interconnect (PCI) express interface, a memory sick (MS) interface, a multi media card (MMC) interface, a compact flash (CF) interface, an integrated device electronics (IDE) interface, or other suitable data transmission interfaces.

Additionally, even though not shown in the present exemplary embodiment, the flash memory controller 110 may further include some general functional modules for controlling the flash memory, such as an error correction unit and a power management unit.

The connector 120 is coupled to the flash memory controller 110 and used to connect the host system 200 through a bus 300. In the present exemplary embodiment, the connector 120 is a SD connector. However, the present invention is not limited thereto, and the connector 120 may also be a SATA connector, a USB connector, an IEEE 1394 connector, a PCI express connector, a MS connector, a MMC connector, a CF connector, an IDE connector, or other suitable connectors.

The flash memory chip 130 is coupled to the flash memory controller 110 for storing data.

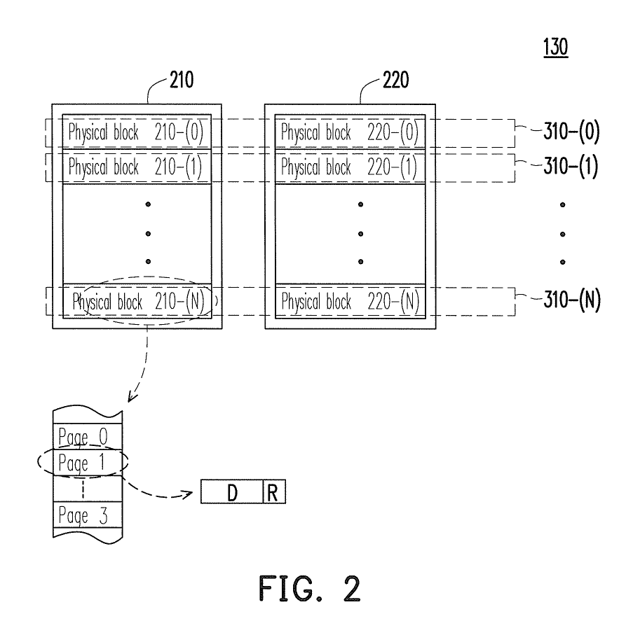

FIG. 2 is a schematic block diagram of a flash memory chip according to an exemplary embodiment of the present invention.

In the present exemplary embodiment, the flash memory chip 130 includes a first flash memory module 210 and a second flash memory module 220, wherein the first flash memory module 210 has physical blocks 210-(0)˜210-(N) and the second flash memory module 220 has physical blocks 220-(0)˜220-(N). Even though the present exemplary embodiment is described with a flash memory chip 130 having two flash memory modules as an example, the number of the flash memory modules is not limited in the present invention. In the present exemplary embodiment, the first flash memory module 210 and the second flash memory module 220 are multi level cell (MLC) NAND flash memories (i.e., each memory cell can store data having 2, 3, or more bits). However, the present invention is not limited thereto, and in another embodiment of the present invention, single level cell (SLC) NAND flash memories may also be applied in the present invention.

In the flash memory chip 130, each physical block is the smallest unit for erasing data. Namely, each physical block has the least number of memory cells which are erased together. A physical block is usually divided into a plurality of pages. Since in the present exemplary embodiment, the first flash memory module 210 and the second flash memory module 220 of the flash memory chip 130 are MLC NAND flash memories, each page is the smallest unit for programming data. In other words, each page is the smallest unit for writing or reading data. A page usually has a user data area D and a redundant area R, wherein the user data area D is used for storing user data, and the redundant area R is used for storing system data (for example, an error checking and correcting (ECC) code). In the present exemplary embodiment, each page of the flash memory chip 130 has a capacity of 8 kilobytes (KB).

In the present exemplary embodiment, each physical block has 192 pages. However, the present invention is not limited thereto, and each physical block may also have 128, 256, or other number of pages. In addition, the physical blocks of the first flash memory module 210 and the second flash memory module 220 are usually grouped into several zones. By managing the physical blocks 210-(0)˜210-(N) and the physical blocks 220-(0)˜220-(N) in unit of zones, the parallelism of the operations can be improved and the management of these physical blocks can be simplified.

Moreover, the flash memory controller 110 logically groups the physical blocks in the first flash memory module 210 and the second flash memory module 220 into a plurality of physical units (for example, each physical unit includes two physical blocks) and erases data in unit of the physical units. By managing the flash memory in unit of the physical units, the flash memory controller 110 maintains the logical unit-physical unit mapping table in greater units (i.e., the physical units), so that the space used in the buffer memory 110d is reduced. In the present exemplary embodiment, the physical blocks 210-(0)˜210-(N) and the physical blocks 220-(0)˜220-(N) are logically grouped into physical units 310-(0)˜310-(N). Even though each physical unit is composed of two physical blocks in the present exemplary, the present invention is not limited thereto, and in another exemplary embodiment of the present invention, each physical unit may also be composed of only one physical block or more than 3 physical blocks.

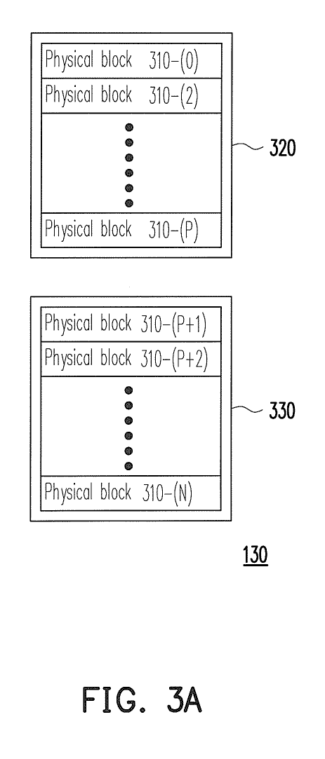

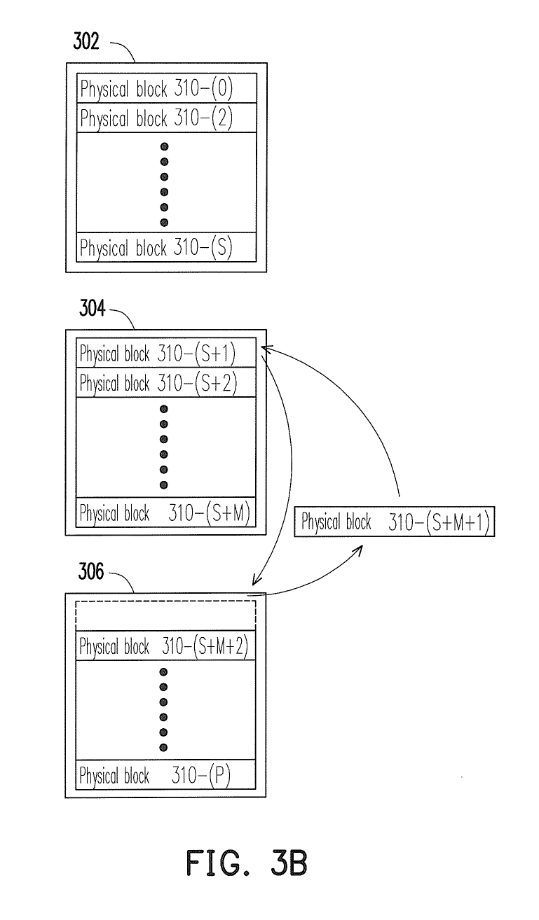

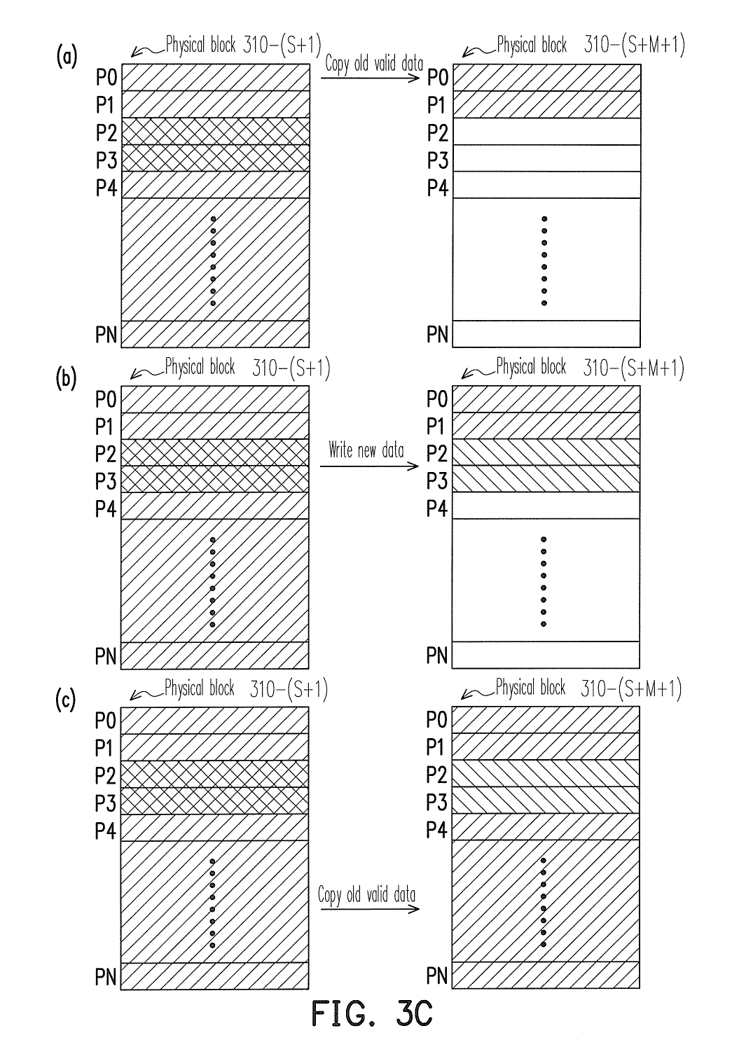

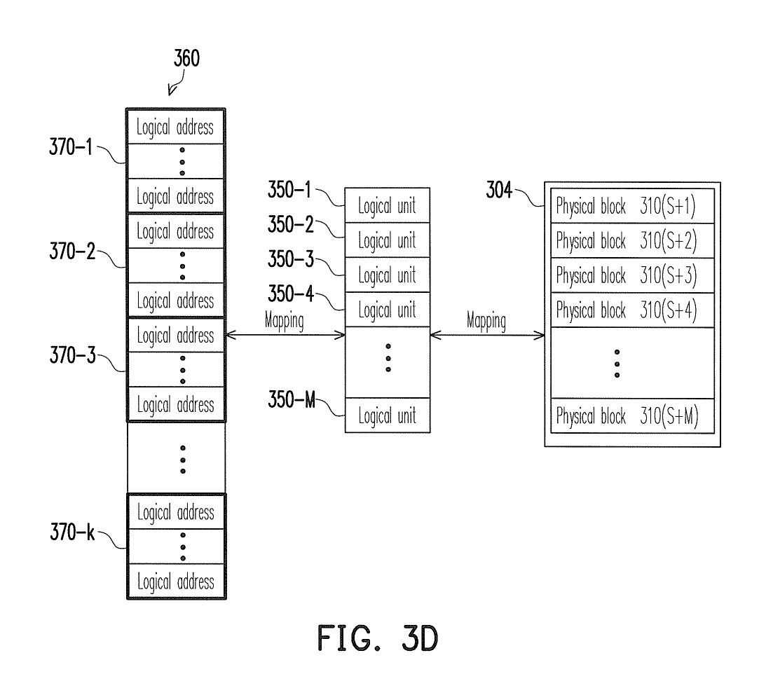

FIGS. 3A˜3D illustrate the operations of a flash memory chip according to an exemplary embodiment of the present invention.

It should be understood that the terms like “select”, “move”, “exchange”, “substitute”, “alternate”, and “group” used for describing the operations performed to the physical blocks in the flash memory chip 130 only refer to logical operations performed to these physical blocks. Namely, the actual positions of the physical blocks in the flash memory chip 130 are not changed. In addition, it should be mentioned that the operations described below are carried out by the memory management unit 110b of the flash memory controller 110.

Referring to FIG. 3A, the memory management unit 110b logically groups the physical blocks in the flash memory chip 130 into physical units 310-(0)˜310-(N) and logically groups the physical units 310-(0)˜310-(N) into a storage area 320 and a substitution area 330.

The physical units 310-(0)˜310-(P) logically belonging to the storage area 320 are physical units normally used in the flash memory storage device 100. Namely, the memory management unit 110b writes data into the physical units in the storage area 320.

The physical units 310-(P+1)˜310-(N) logically belonging to the substitution area 330 are substitution physical units and are used to substitute damaged physical units. For example, when the flash memory chip 130 is just manufactured, 4% of its physical blocks are reserved for substitution purpose. Namely, when a physical block in the storage area 320 is damaged, a physical block in the substitution area 330 is used for substituting the damaged physical block (i.e., a bad block). Accordingly, when there are still available physical blocks in the substitution area 330 and a physical block is damaged, the memory management unit 110b selects a physical block from the substitution area 330 to replace the damaged physical block. When there is no more physical block in the substitution area 330 and a physical block is damaged, the flash memory storage device 100 is announced unusable.

Referring to FIG. 3B, the memory management unit 110b logically groups the physical blocks in the storage area 320 into a system area 302, a data area 304, and a spare area 306.

The system area 302 has physical units 310-(0)˜310-(S), the data area 304 has physical units 310-(S+1)˜310-(S+M), and the spare area 306 has physical units 310-(S+M+1)˜310-(P). In the present exemplary embodiment, S, M, and P are positive integers respectively representing the numbers of physical blocks in the corresponding areas and which can be determined according to the capacities of the flash memory modules by the manufacturer of the flash memory storage system.

The physical units logically belonging to the system area 302 are used to record system data, wherein the system data includes the manufacturer and the model of the flash memory chip, the number of zones in each flash memory module, the number of physical blocks in each zone, and the number of pages in each physical block, etc.

The physical units logically belonging to the data area 304 are used to store user data. Generally speaking, the physical units in the data area 304 are those physical units which are mapped to the logical units accessed by the host system 200. Namely, the physical units in the data area 304 are used to store valid data.

The physical units logically belonging to the spare area 306 are used to alternate with the physical units in the data area 304. Thus, the physical units in the spare area 306 are either blank or available units (i.e., no data is recorded therein or data recorded therein is marked as invalid data). Namely, the physical units in the data area 304 and the spare area 306 are used alternatively to store data that is written by the host system 200 into the flash memory storage device 100.

Referring to both FIG. 3B and FIG. 3C, for example, when the flash memory controller 110 is about to write a data into the physical unit 310-(S+1) in the data area 304, the memory management unit 110b selects a physical unit 310-(S+M+1) from the spare area 306 to substitute the physical unit 310-(S+1) in the data area 304. However, when the memory management unit 110b writes the new data into the physical unit 310-(S+M+1), it does not instantly move all the valid data in the physical unit 310-(S+1) to the physical unit 310-(S+M+1) to erase the physical unit 310-(S+1). To be specific, the memory management unit 110b copies the valid data (i.e., the pages P0 and P1) in the physical unit 310-(S+1) before the page to be written into the physical unit 310-(S+M+1) (as shown in FIG. 3C(a)) and writes the new data (i.e., the pages P2 and P3 in the physical unit 310-(S+M+1)) into the physical unit 310-(S+M+1) (as shown in FIG. 3C(b)). By now, the memory management unit 110b finishes writing the data. Because the valid data in the physical unit 310-(S+1) may become invalid during a next operation (for example, a writing command), instantly moving all the valid data in the physical unit 310-(S+1) to the substitution physical unit 310-(S+M+1) may become meaningless. In the present exemplary embodiment, the action for temporarily maintaining such a mother-child relationship (i.e., the physical unit 310-(S+1) and the physical unit 310-(S+M+1)) is referred to as opening mother-child units. Because how data is distributed into a plurality of physical units has to be recorded in a buffer memory (not shown) when the mother-child units are opened, the number of the mother-child units opened in the flash memory storage device 100 at the same time is determined according to the size of the buffer memory in the flash memory controller 110.

Thereafter, when the contents of the physical unit 310-(S+1) and the physical unit 310-(S+M+1) are to be actually combined, the memory management unit 110b integrates the physical unit 310-(S+1) and the physical unit 310-(S+M+1) into a single physical unit, so that the efficiency of using the physical units is improved. This action of integrating the mother-child units is referred to as closing the mother-child units. For example, as shown in FIG. 3C(c), while closing the mother-child units, the memory management unit 110b copies the remaining valid data (i.e., the pages P4˜PN) in the physical unit 310-(S+1) to the substitution physical unit 310-(S+M+1) and then erases the physical unit 310-(S+1) and links it to the spare area 306, and meanwhile, the memory management unit 110b links the physical unit 310-(S+M+1) to the data area 304.

Referring to FIG. 3D, in particular, because the physical units of the flash memory chip 130 are alternatively used for storing data from the host system 200, the memory management unit 110b provides logical addresses 360 to the host system 200 to access the data. Because as described above, the memory management unit 110b manages the flash memory in units of the physical units and the pages, the memory management unit 110b provides logical units 350-1˜350-M mapped to the logical addresses 360. For example, in the present exemplary embodiment, the memory management unit 110b records the mapping relationship between the logical addresses and the logical units in a logical address-logical unit mapping table and records the mapping relationship between the physical units and the logical units in a logical unit-physical unit mapping table. To be specific, when the host system 200 is about to access a specific logical address, the memory management unit 110b identifies the logical unit mapped to the logical address through a configuration unit (not shown) or an equation and identifies the physical unit mapped to the logical unit according to the logical unit-physical unit mapping table. After that, the memory management unit 110b access data in the flash memory chip 130 according to foregoing mapping relationship. In the present exemplary embodiment, the configuration unit records the mapping relationship between the logical addresses and the logical units in a logical address-logical block mapping table.

In another exemplary embodiment of the present invention, the configuration unit may also reflect the mapping relationship between the logical addresses and the logical units with an equation. For example, if each sector is 1 megabyte (MB) and each storage unit is 4 MB, the configuration unit divides the logical addresses by 4 and obtains the remainder. When the remainder is 3, the configuration unit writes the data corresponding to the logical address into the corresponding secondary logical unit, and when the remainder is not 3, the configuration unit writes the data into the corresponding logical unit according to the quotient. For example, when the configuration unit performs the remainder calculation to the logical address 0, the quotient is 0 and the remainder is not 3. Thus, the data corresponding to the logical address 0 is written into the primary logical unit 350-1. When the configuration unit performs the remainder calculation to the logical address 4, the quotient is 1 and the remainder is not 3. Thus, the data corresponding to the logical address 4 is written into the primary logical unit 350-2. When the configuration unit performs the remainder calculation to the logical address 3, the quotient is 0 and the remainder is 3. Thus, the data corresponding to the logical address 3 is written into the secondary logical unit 350-4.

In the present exemplary embodiment, generally speaking, when the physical units mapped to the logical units are not mother-child units, the logical units and the physical units are usually mapped one to one in the logical unit-physical unit mapping table (i.e., one logical unit is mapped to one physical unit), and when the physical units mapped to the logical units are mother-child units, the logical units and the physical units are usually mapped one to multiple in the logical unit-physical unit mapping table (i.e., one logical unit is mapped to multiple physical units). It should be understood that in the present exemplary embodiment, the mapping relationship between the logical units and the physical units is recorded in the logical unit-physical unit mapping table, while in another exemplary embodiment of the present invention, the mapping relationship between the logical units and the physical units may be recorded in a plurality of tables or in the redundant area of each physical unit.

In addition, in the logical address-logical unit mapping table, the logical addresses 360 are mapped to the logical units 350-1˜350-M in a non-continuous manner. To be specific, the memory management unit 110b groups the logical units 350-1˜350-M into a plurality of logical unit groups respectively having primary logical units and secondary logical units and sequentially groups the logical addresses 360 into storage units 370-1˜370-K. Besides, the memory management unit 110b divides each of the storage units into a first sub storage unit and a second sub storage unit and maps the first sub storage unit and the second sub storage unit of each storage unit to the primary logical units and the secondary logical units in a non-continuous manner. In an exemplary embodiment of the present invention, the size of a logical unit group is the least common multiple of the size of a logical unit and the size of a storage unit. However, the size of each logical unit group may also be determined according to the user's actual requirement. For example, each logical unit group is determined to be 12 MB if each logical unit is 3 MB and each storage unit is 4 MB.

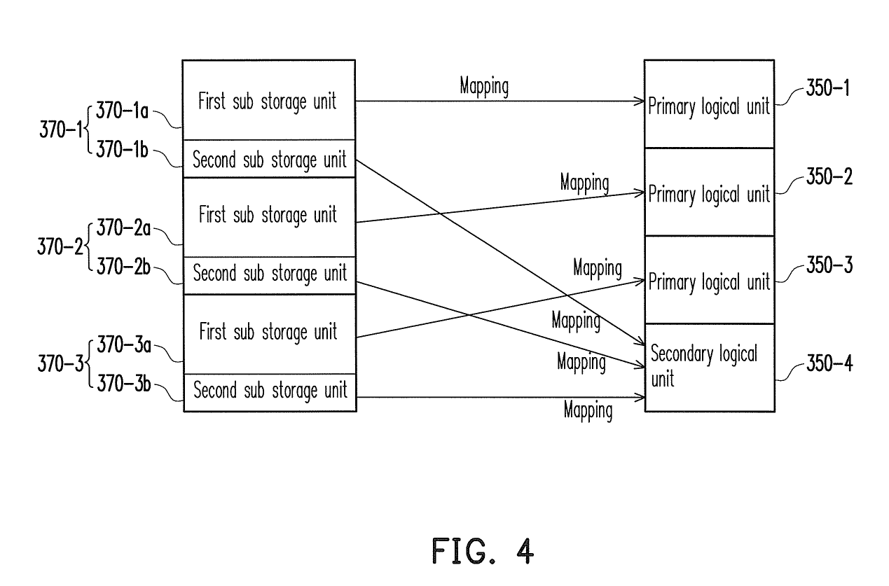

FIG. 4 illustrates the mappings between logical addresses and logical blocks according to an exemplary embodiment of the present invention. It has to be understood that in the present exemplary embodiment, the logical addresses of all the storage units 370-1˜370-K are mapped to the logical units in the same way. Thus, the mapping between the logical addresses of the storage units 370-1˜370-3 and the logical unit group composed of the logical units 350-1˜350-4 will be described below as an example.

Referring to FIG. 4, the memory management unit 110b divides the storage unit 370-1 into a first sub storage unit 370-1a and a second sub storage unit 370-1b, divides the storage unit 370-2 into a first sub storage unit 370-2a and a second sub storage unit 370-2b, and divides the storage unit 370-3 into a first sub storage unit 370-3a and a second sub storage unit 370-3b. Besides, the memory management unit 110b selects the logical unit 350-4 as a secondary logical unit and the other logical units (i.e., the logical units 350-1˜350-3) as the primary logical units.

In the present exemplary embodiment, each physical unit is 3 MB, and accordingly each logical unit is also 3 MB. It should be mentioned that each of the storage units (i.e., the storage units 370-1˜370-K) is 4 MB. The memory management unit 110b groups 3 MB logical addresses in each storage unit into a first sub storage unit and 1 MB logical addresses into a second sub storage unit. Accordingly, the memory management unit 110b maps the first sub storage unit 370-1a to the primary logical unit 350-1, the first sub storage unit 370-2a to the primary logical unit 350-2, the first sub storage unit 370-3a to the primary logical unit 350-3, and the second sub storage units 370-1b, 370-2b, and 370-3b to the secondary logical unit 350-4. Besides, these mapping relationships are recorded in the logical address-logical block mapping table.

For example, when the host system 200 is about to write data at a logical address in the first sub storage unit 370-1a of the storage unit 370, the memory management unit 110b identifies the logical unit 350-1 mapped to the first sub storage unit 370-1a according to the logical address-logical block mapping table and writes the data into the corresponding physical unit according to the logical block-physical block mapping table (as shown in FIG. 3B and FIG. 3C). When the host system 200 is about to write data into a logical address in the second sub storage unit 370-1b of the storage unit 370, the memory management unit 110b identifies the logical unit 350-4 mapped to the second sub storage unit 370-1b according to the logical address-logical block mapping table and writes the data into the corresponding physical unit according to the logical block-physical block mapping table (as shown in FIG. 3B and FIG. 3C). Similarly, when the host system 200 is about to write data into a logical address in the first sub storage unit 370-2a, the memory management unit 110b writes the data into the physical unit mapped to the logical unit 350-2. When the host system 200 is about to write data into a logical address in the first sub storage unit 370-3a, the memory management unit 110b writes the data into a physical unit mapped to the logical unit 350-3. When the host system 200 is about to write data into a logical address in the second sub storage unit 370-2b or the second sub storage unit 370-3b, the memory management unit 110b writes the data into the physical unit mapped to the logical unit 350-4.

As described above, when the host system 200 writes data into the flash memory chip 130 in unit of the storage units, the memory management unit 110b writes part of the data that fills up an entire logical unit into the physical unit mapped to the primary logical unit (for example, the logical unit 350-1) and the other part of the data that is not enough for filling up an entire logical unit into the secondary logical unit. By storing fragmental data (i.e., data not enough for a logical unit) in the physical unit mapped to a secondary logical unit (for example, the logical unit 350-4), the quantity of data to be moved (or copied, as shown in FIG. 3C) can be effectively reduced, and accordingly the writing speed of the flash memory storage device 100 can be increased.

It should be mentioned that in the present exemplary embodiment, each storage unit (or a test unit) is 4 MB and each logical unit is 3 MB. Thus, each secondary logical unit can store fragmental data (i.e., data in the second sub storage unit) corresponding to 3 storage units. However, the present invention is not limited thereto, and those having ordinary knowledge in the art should be able to determine the number of second sub storage units mapped to each secondary logical unit according to the sizes of the physical units, logical units, and storage units (or test units) in the flash memory chip.

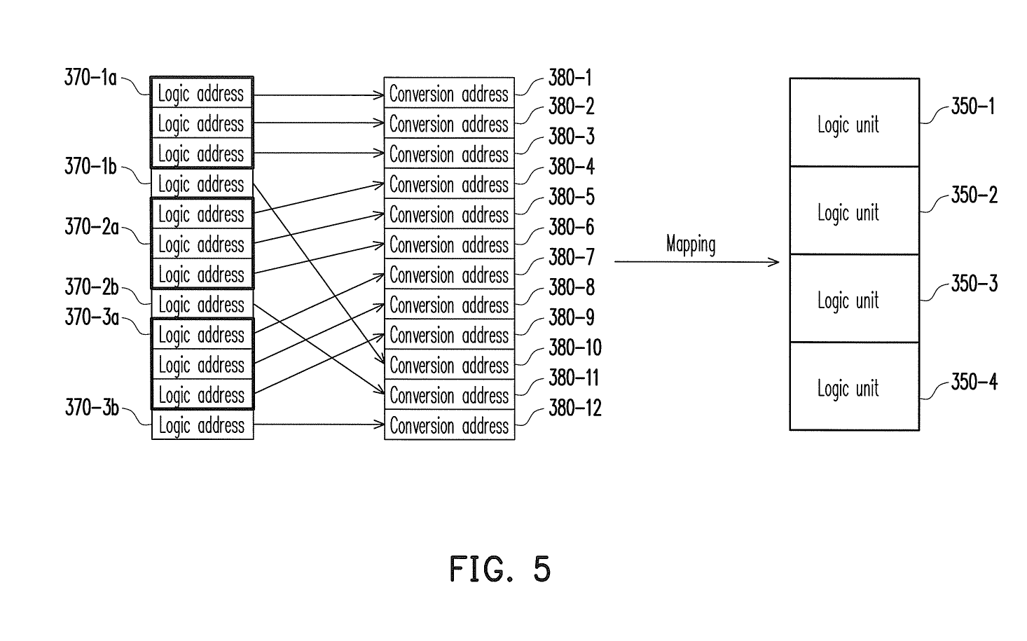

It should be mentioned that the mapping pattern illustrated in FIG. 4 is to directly map the logical addresses of the storage units 370-1˜370-K to the logical units 350-1˜350-M in a non-continuous manner. In another exemplary embodiment of the present invention, the logical addresses of the storage units 370-1˜370-K may also be indirectly mapped to the logical units 350-1˜350-M through address conversion. FIG. 5 illustrates the mappings between logical addresses and logical blocks according to another exemplary embodiment of the present invention, wherein the mapping between the logical addresses of the storage units 370-1˜370-3 and a logical unit group composed of the logical units 350-1˜350-4 is described as an example.

Referring to FIG. 5, conversion units 380-1˜380-12 are configured between the storage units 370-1˜370-3 and the logical units 350-1˜350-4, wherein the conversion units 380-1˜380-3 are mapped to the logical unit 350-1, the conversion units 380-4˜380-6 are mapped to the logical unit 350-2, the conversion units 380-7˜380-9 are mapped to the logical unit 350-3, and the conversion units 380-10˜380-12 are mapped to the logical unit 350-4. In the present example, the logical address of the first sub storage unit 370-1a is converted into conversion addresses 380-1˜380-3, the logical address of the first sub storage unit 370-2a is converted into conversion addresses 380-4˜380-6, the logical address of the first sub storage unit 370-3a is converted into conversion addresses 380-7˜380-9, the logical address of the second sub storage unit 370-1b is converted into a logical address 380-10, the logical address of the second sub storage unit 370-2b is converted into a logical address 380-11, and the logical address of the second sub storage unit 370-3b is converted into a logical address 380-12. Accordingly, when the host system 200 writes data according to the logical address, the memory management unit first converts the logical address for writing the data into the conversion addresses.

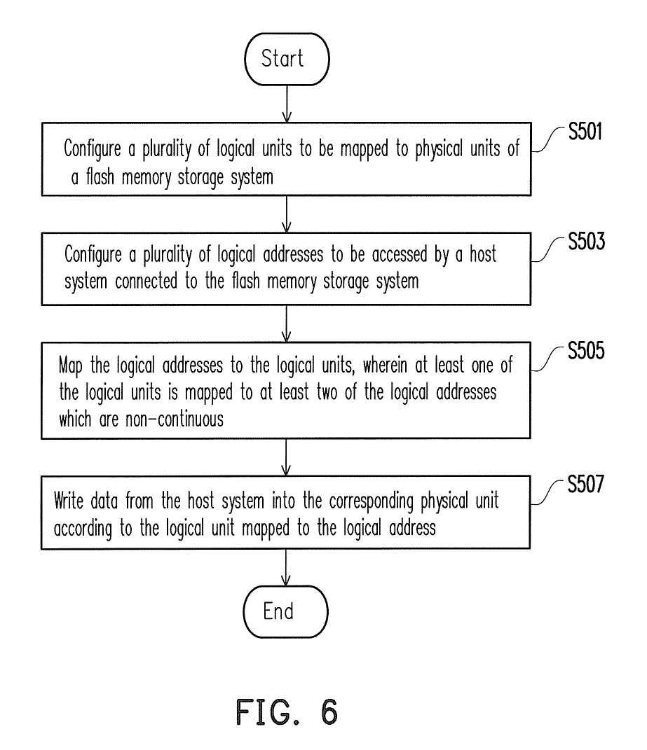

FIG. 6 is a flowchart of a data writing method according to an exemplary embodiment of the present invention. It should be mentioned that the data writing method in the present exemplary embodiment is executed by the flash memory controller 110.

Referring to FIG. 6, first, in step S501, the memory management unit 110b configures a plurality of logical units mapped to the physical units of a flash memory storage system (i.e., the flash memory storage device 100). Namely, the memory management unit 110b of the flash memory controller 110 configures the logical units mapped to the physical units such that data can be alternatively written into or read from the physical units 310-(S+1)˜310(S+M) of the flash memory chip 130. As described above, in the present exemplary embodiment, the memory management unit 110b records the mapping relationship in the logical unit-physical unit mapping table, and the logical unit-physical unit mapping table is updated in real time.

Next, in step S503, the memory management unit 110b configures a plurality of logical addresses to be accessed by a host system (for example, the host system 200) connected to the flash memory storage system. To be specific, because the host system 200 accesses data in a specific file system, the memory management unit 110b configures a plurality of logical addresses corresponding to the file system of the host system 200 so that the host system 200 can access the flash memory storage device 100 successfully. For example, when the host system 200 accesses data in unit of sectors, the memory management unit 110b configures logical addresses in unit of sectors.

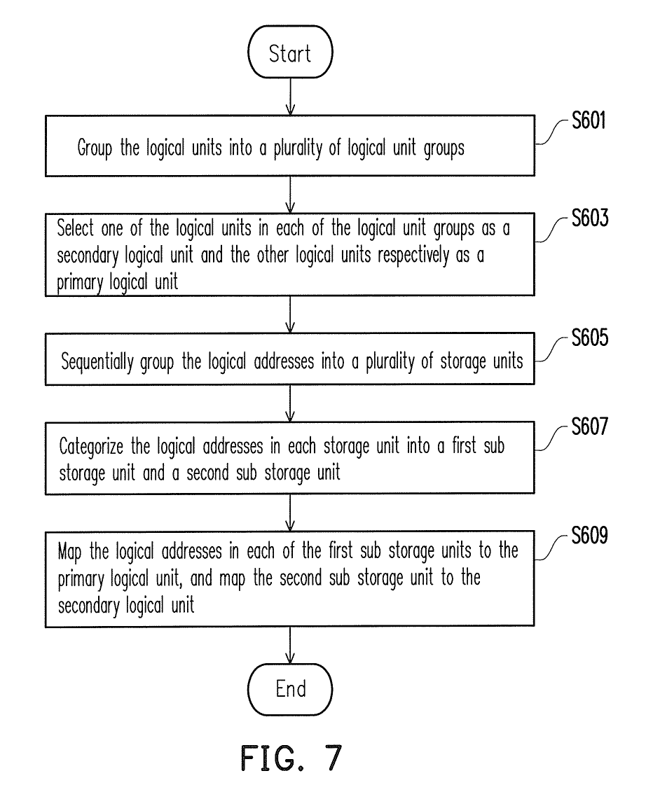

Thereafter, in step S505, the memory management unit 110b maps the logical addresses to the logical units in a non-continuous manner. In this step, by mapping the logical addresses and the logical blocks in the non-continuous manner, data to be moved by the flash memory storage device 100 is reduced when the host system 200 writes data in unit of the storage units (or test units), and accordingly the data writing speed of the flash memory storage device 100 is improved. FIG. 7 is a detailed flowchart of step S505 in FIG. 6 according to an exemplary embodiment of the present invention.

Referring to FIG. 7, first, in step S601, the memory management unit 110b groups the logical units into a plurality of logical unit groups. For example, in the present exemplary embodiment, one logical unit group is composed of 4 logical units (for example, the logical units 350-1, 350-2, 350-3, and 350-4, as shown in FIG. 4).

After that, in step S603, the memory management unit 110b selects one of the logical units in each of the logical unit groups as a secondary logical unit (for example, the logical unit 350-4) and the other logical units respectively as a primary logical unit (for example, the logical units 350-1, 350-2, and 350-3). After that, in step S605, the memory management unit 110b sequentially groups the logical addresses into a plurality of storage units, and in step S607, the memory management unit 110b categorizes the logical addresses in each storage unit into a first sub storage unit (for example, the first sub storage unit 710-1a) and a second sub storage unit (for example, the second sub storage unit 710-1b). Finally, in step S609, the memory management unit 110b maps the logical addresses in each first sub storage unit to the primary logical units and maps the second sub storage unit to the secondary logical units. The method for mapping the logical addresses and the logical units in the non-continuous method has been described above with reference to FIG. 4 therefore will not be described herein.

In the present exemplary embodiment, the memory management unit 110b records the mapping relationship into a logical address-logical unit mapping table after executing the steps illustrated in FIG. 7.

Referring to FIG. 6 again, in step S507, the memory management unit 110b writes the data from the host system into the corresponding physical units according to the logical units mapped to the logical addresses. To be specific, the memory management unit 110b writes the data to be written by the host system into the corresponding physical units according to the logical address-logical unit mapping table and the logical unit-physical unit mapping table.

As described above, in exemplary embodiments of the present invention, logical addresses are grouped in unit of storage units (or test units) used by a host system, each of the storage units is divided into a first sub storage unit having the same capacity as a logical unit and a second sub storage unit having the capacity smaller than that of a logical unit, and a single logical unit (i.e., the secondary logical unit) is configured for storing fragmental data in the second sub storage unit. The previously described exemplary embodiments of the present invention have many advantages, including the data to be copied when the flash memory storage device executes a write command is reduced and the writing speed of the flash memory storage device is increased, wherein the advantages aforementioned not required in all versions of the invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data writing method, for writing data into a flash memory chip, wherein the flash memory chip comprises a plurality of physical units, the data writing method comprising:
providing a flash memory control circuit;
configuring a plurality of logical units, wherein each of the logical units is mapped to at least one of the physical units;
configuring a plurality of logical addresses to be accessed by a host system;
mapping the logical addresses to the logical units, wherein at least one of the logical units is mapped to at least two of the logical addresses which are non-continuous; and
when the host system stores the data in the logical addresses, the flash memory control circuit writes the data from the host system into the corresponding physical units according to the logical units mapped to the logical addresses, wherein data stored in the logical addresses mapped to the same logical units is simultaneously erased.

2. The data writing method according to claim 1, wherein the step of mapping the logical addresses to the logical units comprises:
grouping the logical units into a plurality of logical unit groups;
selecting one of the logical units in each of the logical unit groups as a secondary logical unit and the other logical units in the logical unit group respectively as a primary logical unit;
sequentially grouping the logical addresses into a plurality of storage units;
categorizing the logical addresses of each of the storage units as a first sub storage unit and a second sub storage unit; and
mapping the logical addresses of each of the first sub storage units to one of the primary logical units, and mapping the second sub storage units to the secondary logical units, wherein each of the secondary logical units is mapped to at least two of the second sub storage units.

3. The data writing method according to claim 2, wherein the size of each of the first sub storage units is the same as the size of each of the logical units.

4. The data writing method according to claim 2, wherein the size of each of the logical units is smaller than the size of each of the storage units.

5. The data writing method according to claim 2, wherein each of the logical unit groups comprises 4 of the logical units, and each of the logical unit groups is mapped to 3 of the storage units.

6. The data writing method according to claim 5, wherein each of the secondary logical units is mapped to 3 of the second sub storage units, and each of the primary logical units is mapped to one of the first sub storage units.

7. The data writing method according to claim 6, wherein each of the physical units is 3 megabytes (MB), each of the logical units is 3 MB, and each of the storage units is 4 MB.

8. The data writing method according to claim 1 further comprising determining a mapping relationship between the logical addresses and the logical units by using a logical address-logical unit mapping table or an equation.

9. The data writing method according to claim 1, wherein the step of mapping the logical addresses to the logical units comprises:
configuring a plurality of conversion addresses, wherein the conversion addresses are mapped to the logical units in a continuous manner; and
converting the logical addresses into the conversion addresses in a non-continuous manner.

10. The data writing method according to claim 2, wherein the size of each of the logical unit groups is a least common multiple of the size of each of the logical units and the size of each of the storage units.

11. A flash memory control circuit, for controlling a flash memory chip to write data from a host system into a plurality of physical blocks of the flash memory chip, the flash memory control circuit comprising:
a microprocessor unit;
a flash memory interface unit, coupled to the microprocessor unit, and used to connect the flash memory chip;
a host interface unit, coupled to the microprocessor unit, and used to connect the host system; and
a memory management unit, coupled to the microprocessor unit, and used to configure a plurality of logical units mapped to the physical units and a plurality of logical addresses to be accessed by the host system, and map the logical addresses to the logical units, wherein at least one of the logical units is mapped to at least two of the logical addresses which are non-continuous, and each of the logical units is mapped to at least one of the physical units,
wherein the memory management unit writes the data from the host system into the corresponding physical units according to the logical units mapped to the logical addresses, and
wherein data stored in the logical addresses mapped to the same logical units is simultaneously erased.

12. The flash memory control circuit according to claim 11, wherein the memory management unit groups the logical units into a plurality of logical unit groups, selects one of the logical units in each of the logical unit groups as a secondary logical unit and the other logical units respectively as a primary logical unit, sequentially groups the logical addresses into a plurality of storage units, divides each of the storage units into a first sub storage unit and a second sub storage unit, maps the logical address of each of the first sub storage units to one of the primary logical units, and maps the second sub storage units to the secondary logical units, wherein each of the secondary logical units is mapped to at least two of the second sub storage units.

13. The flash memory control circuit according to claim 12, wherein the size of each of the first sub storage units is the same as the size of each of the logical units.

14. The flash memory control circuit according to claim 12, wherein the size of each of the logical units is smaller than the size of each of the storage units.

15. The flash memory control circuit according to claim 12, wherein each of the logical unit groups comprises 4 of the logical units, and each of the logical unit groups is mapped to 3 of the storage units.

16. The flash memory control circuit according to claim 15, wherein each of the secondary logical units is mapped to 3 of the second sub storage units, and each of the primary logical units is mapped to one of the first sub storage units.

17. The flash memory control circuit according to claim 16, wherein each of the physical units is 3 MB, each of the logical units is 3 MB, and each of the storage units is 4 MB.

18. The flash memory control circuit according to claim 11, wherein the memory management unit determines a mapping relationship between the logical addresses and the logical units according to a logical address-logical unit mapping table or an equation.

19. The flash memory control circuit according to claim 11, wherein the memory management unit configures a plurality of conversion addresses and converts the logical addresses into the conversion addresses in a non-continuous manner, wherein the conversion addresses are mapped to the logical units in a continuous manner.

20. A flash memory storage system, for storing data from a host system, the flash memory storage system comprising:
a connector, used to connect the host system;
a flash memory chip, having a plurality of physical blocks; and
a flash memory controller, coupled to the connector and the flash memory chip, and used to configure a plurality of logical units mapped to the physical units and a plurality of logical addresses to be accessed by the host system, and map the logical addresses to the logical units, wherein at least one of the logical units is mapped to at least two of the logical addresses which are non-continuous, and each of the logical units is mapped to at least one of the physical units,
wherein the flash memory controller writes the data from the host system into the corresponding physical units according to the logical units mapped to the logical addresses, and
wherein data stored in the logical addresses mapped to the same logical units is simultaneously erased.
